(19) United States
(12) Patent Application Publication
(10) Pub. No.: US 2026/0069907 A1
(43) Pub. Date: Mar. 12, 2026

(54) FIRE SUPPRESSION SYSTEM WITH REGULATOR

(71) Applicant: Tyco Fire Products LP, Cranston, RI (US)

(72) Inventors: Alexander Louis Starzynski, Marinette, WI (US); Joel Allen Clishe, Escanaba, MI (US)

(73) Assignee: Tyco Fire Products LP, Cranston, RI (US)

(21) Appl. No.: 19/105,154

(22) PCT Filed: Oct. 3, 2023
(86) PCT No.: PCT/IB2023/059935

§ 371 Date: Feb. 20, 2025

Related U.S. Application Data
(60) Provisional application No. 63/413,018, filed on Oct. 4, 2022.

(51) Int. Cl. A62C 35/02; A62C 35/13; A62C 35/68; A62C 99/00

(52) U.S. Cl. CPC A62C 35/023; A62C 35/13; A62C 35/68; A62C 99/0018

(57) ABSTRACT

A fire suppression system includes a first suppressant container and a second suppressant container each containing fire suppressant, a conduit fluidly coupled to the first suppressant container and the second suppressant container, a pressure regulator fluidly coupled to the conduit and configured to receive the fire suppressant from the conduit at a first pressure and supply the fire suppressant at a second pressure lower than the first pressure, and a valve fluidly coupled to the pressure regulator and configured to selectively supply the fire suppressant to a hazard.

### CROSS-REFERENCE TO RELATED PATENT APPLICATION

This application claims the benefit of and priority to U.S. Provisional Application No. 63/413,018, filed on Oct. 4, 2022, the entire disclosure of which is hereby incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant (e.g., an agent) throughout the area. The fire suppressant then extinguishes or otherwise controls the fire.

### SUMMARY

At least one embodiment relates to a fire suppression system. The fire suppression system includes a first suppressant container and a second suppressant container each containing fire suppressant, a conduit fluidly coupled to the first suppressant container and the second suppressant container, a pressure regulator fluidly coupled to the conduit and configured to receive the fire suppressant from the conduit at a first pressure and supply the fire suppressant at a second pressure lower than the first pressure, and a valve fluidly coupled to the pressure regulator and configured to selectively supply the fire suppressant to a hazard.

Another embodiment relates to a fire suppression system including a manifold defining a distribution volume, a first cylinder subassembly and a second cylinder subassembly, a valve fluidly coupled to the manifold, a controller operatively coupled to the valve, and a check valve. The first cylinder subassembly includes a first cylinder and a second cylinder each containing fire suppressant and a first pressure regulator fluidly coupled to the first cylinder and the second cylinder. The second cylinder subassembly includes a third cylinder and a fourth cylinder each containing fire suppressant and a second pressure regulator fluidly coupled to the third cylinder and the fourth cylinder. The valve is configured to selectively supply the fire suppressant from the distribution volume to a hazard. The controller is configured to activate the valve to supply the fire suppressant to the hazard in response to an indication that a fire is present. The check valve is positioned to prevent fluid flow from the manifold to the first cylinder through the first pressure regulator.

Another embodiment relates to a method of suppressing a fire. The method includes (a) supplying a first volume of a fire suppressant from a first suppressant container to a pressure regulator, (b) supplying a second volume of the fire suppressant from a second suppressant container to the pressure regulator, (c) reducing, by the pressure regulator, a pressure of the first volume of the fire suppressant and a pressure of the second volume of the fire suppressant to a reduced pressure, and (d) directing the first volume of the fire suppressant and the second volume of the fire suppressant toward a hazard.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic of a fire suppression system, according to an exemplary embodiment.

FIG. 2 is a block diagram of a control system for a fire suppression system, according to an exemplary embodiment.

FIG. 3 is a schematic of a fire suppression system, according to another exemplary embodiment.

FIG. 4 is a schematic of a fire suppression system, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Water is commonly used in fire suppression systems that suppress fires in different types of areas (e.g., office buildings, homes, schools, etc.). Water is often effective at extinguishing fires fueled by common flammable materials such as wood, paper, and cloth. However, in certain scenarios, water may be undesirable for use as a fire suppressant. When extinguishing fires near certain types of objects, such as books or electronic components, exposure to water can damage the objects that the fire suppression system is designed to protect. Accordingly, in certain environments, such as power plants, telecommunications facilities, aircraft, transport, data centers, medical facilities, and museums, application-specific suppressants (e.g., noble gasses, inergen IG-541, IG-55, inert gas mixture, etc.) are used to suppress fires instead of and/or in addition to water. These chemicals may be configured to suppress or control fires without causing damage to sensitive objects or requiring extensive clean-up.

Referring generally to the figures, a fire suppression system is shown, according to various embodiments. The fire suppression system includes a series of cylinder subassemblies each including multiple cylinders of fire suppressant that are fluidly coupled to one another. Each cylinder subassembly is fluidly coupled to a pressure regulator that regulates the fire suppressant in a gaseous form from a first higher pressure to a second lower pressure downstream of the pressure regulator. By connecting several cylinders of fire suppressant to a single pressure regulator, the number of components and cost of the system can be reduced relative to a system that utilizes a pressure regulator at each cylinder. Additionally, all components downstream of the pressure regulators can be rated to operate at the second lower pressure instead of the first higher pressure, reducing the requirements and cost of the system.

The pressure regulators are fluidly coupled to a manifold that unites the flows of fire suppressant coming out of the pressure regulators. The manifold fluidly couples the pressure regulators to a series of valves. Each valve selectively supplies the fire suppressant to a hazard (e.g., to different hazards). A controller identifies one or more of the hazards as requiring a distribution of fire suppressant. By way of example, the controller may identify the hazard based on at least one of a manual activation by a user (e.g., pull lever, switch, button, etc.) or automatic activation by a sensor (e.g., temperature sensor, infrared sensor, etc.). The controller may then activate the valve associated with the identified hazard, sending fire suppressant toward the identified hazard and suppressing a fire. The fire suppression system may utilize a chemical fire suppressant that prevents and/or minimizes damage to components in the environment (e.g., server rooms, computer rooms, etc.).

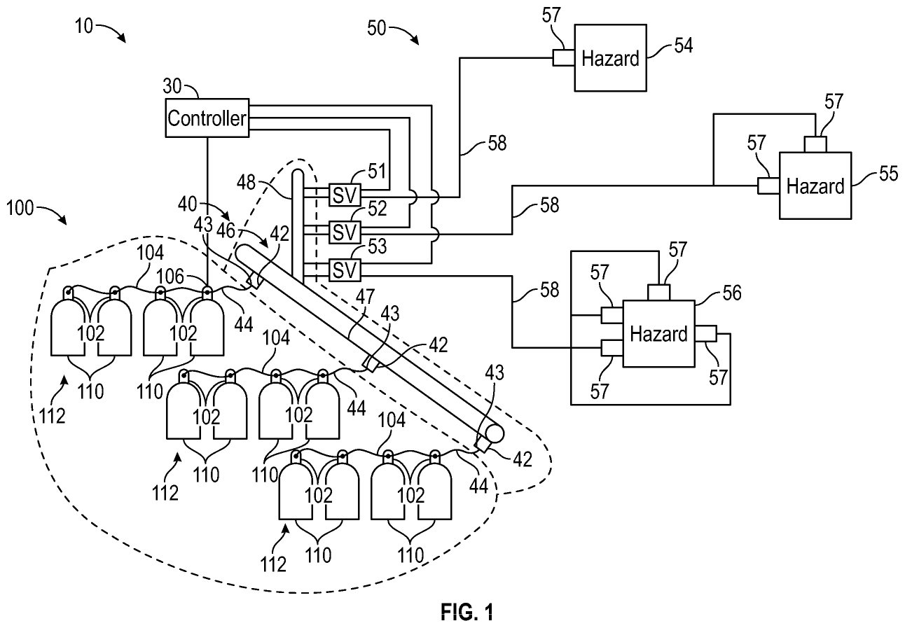

Referring to FIG. 1, a fire suppression system is shown as a system 10, according to one embodiment. The fire suppression system 10 is configured to supply fire suppressant to one or more potentially flammable objects or areas to be protected, shown as hazards 54, 55, and 56. The fire suppression system 10 includes a supply of fire suppressant (e.g., a suppressant supply assembly), shown as fire suppressant supply 100, which provides the fire suppressant for distribution by the fire suppression system 10 to address the hazards 54, 55, and 56. The fire suppression system 10 supplies the fire suppressant onto and/or around the hazards 54, 55, 56, controlling or suppressing fires associated with (e.g., on, affecting, nearby, etc.) the hazards 54, 55, 56. The fire suppression system 10 includes a controller 30 configured to selectively operate one or more control valves (e.g., electrically-actuated valves, pneumatically-actuated valves, etc.), shown as selector valves 51, 52, and 53, based on an activation signal. A pressure regulating portion 40 (e.g., a pressure regulation assembly) fluidly couples the selector valves 51, 52, and 53 to the fire suppressant supply 100. The pressure regulating portion 40 supplies the fire suppressant to a distribution network 50 downstream from selector valves 51, 52, 53 at a decreased pressure, where the fire suppressant is then distributed to address the hazards 54, 55, and 56. The fire suppression system 10 can be used alone or in combination with other types of fire suppression systems (e.g., a building sprinkler system, a portable fire extinguisher, etc.). In some embodiments, multiple fire suppression systems 10 are used in combination with one another to cover a larger area (e.g., each in different rooms of a building, etc.).

In some embodiments, the fire suppression system 10 is a clean agent system that is configured to suppress fires associated with the hazards 54, 55, 56 while limiting damage to nearby assets. The fire suppressant distributed by the fire suppression system 10 may include a clean agent fire suppressant such as Inergen IG-541. In other embodiments, the fire suppressant includes a noble gas, IG-55, IG-01, IG-100, and/or any other inert gas or mixture of gases. Clean agents are useful in certain applications where delicate and/or valuable items or information (e.g., hard drives, power supplies, books, etc.) are stored. By way of example, the fire suppression system 10 may be used to protect telecommunication sites, data centers, archives, museums, oil and gas facilities, power plants, or other areas. The clean agent fire suppressant may leave no or substantially no residue on the assets after distributed by the fire suppression system 10. In other embodiments, the fire suppression system 10 utilizes other types of agents.

The fire suppressant supply 100 includes a series of containers (e.g., vessels, suppressant containers, vats, drums, tanks, canisters, cartridges, or cans, etc.), shown as cylinders 110, that each contain a volume of fire suppressant. The cylinders 110 are arranged in groups or subassemblies (e.g., container subassemblies), shown as cylinder subassemblies 112. Each cylinder 110 is coupled to a valve, puncture device, or activator assembly, shown as actuator 102. The actuators 102 are configured to selectively fluidly couple an internal volume of each cylinder 110 to a conduit (e.g., a hose, a pipe, a tube, etc.), shown as supply conduit 104. In some embodiments, the actuators 102 are manually actuated by a user (e.g., by hand). By way of example, an operator may manually open the actuators 102 when initially setting up the system 10. In other embodiments, the actuators 102 are actuated by a signal (e.g., an electrical signal, a flow of pressurized fluid, etc.). In other embodiments, the actuators 102 are omitted, and the cylinders 110 are directly coupled to the supply conduit 104.

The supply conduit 104 fluidly couples the cylinders 110 to one other, such that the cylinder subassembly 112 has a single, continuous volume. The supply conduit 104 may be an assembly including one or more straight or bent sections of conduit and/or one or more fittings. In some embodiments, the fire suppressant within the cylinders 110 is pressurized to at least 200 bar (e.g., at least 205 bar, at least 210 bar, etc.). 200 bar may be greater than the storage pressure used in other fire suppression systems. Increasing the storage pressure of the cylinders 110 facilitates storing the fire suppressant, which may be or include a gas, in a smaller volume at a higher fill density, and in turn reduces the overall area required to store the cylinder subassembly 112 (e.g., the footprint of the cylinder subassembly 112). In other embodiments, the fire suppressant contained in one or more cylinders 110 may be at different pressures (e.g., a pressure less than 200 bar). In other embodiments, the fire suppressant within the cylinders 110 is pressurized to at least 300 bar.

Each cylinder 110 may be a non-refillable cylinder designed for one-time use, such that the cylinders 110 are not refilled or reused. In other embodiments, each cylinder 110 is refillable and capable of repeated use. Each cylinder 110 may be manufactured from a metal material (e.g., steel, aluminum, etc.). In other embodiments, the cylinders 110 are manufactured from different materials and/or combinations of materials (e.g., a composite, such as fiberglass or carbon fiber).

In some embodiments, the supply conduit 104 fluidly couples the actuators 102 to one another. By way of example, within a cylinder subassembly 112 a first supply conduit 104 may fluidly couple a first actuator 102 to a second actuator 102. A second supply conduit 104 may fluidly couple the second actuator 102 to a third actuator 102. This arrangement may be repeated to fluidly couple each of the actuators 102 of the cylinder subassembly 112 to one another. A final supply conduit 104 may fluidly couple the final cylinder 110 of the cylinder subassembly 112 to the pressure regulating portion 40.

A sensor (e.g., pressure sensor, strain-gauge, piezometer, manometer, etc.), shown as pressure sensor 106, is coupled to the cylinder subassembly 112 (e.g., to an individual cylinder 110) and is configured to detect the pressure of the fire suppressant within the cylinder subassembly 112. The pressure sensor 106 may be used to monitor the performance of the fire suppression system 10 and indicate if maintenance is required. By way of example, the pressure sensor 106 may measure a pressure of the cylinder subassembly 112 and send an indication to the controller 30 that maintenance is required (e.g., to address a leak in the supply conduit, etc.) if the measured pressure is higher or lower than a pressure threshold. Each cylinder subassembly 112 may be coupled to a different pressure sensor 106. The pressure sensor 106 is operatively coupled to the controller 30.

Referring further to FIG. 1, each cylinder subassembly 112 includes one or more cylinders 110 fluidly coupled to a supply conduit 104. The cylinders 110 included in the cylinder subassembly 112 may be connected in parallel such that the cylinders 110 each supply fire suppressant at approximately the same rate. In other embodiments, the cylinders 110 included in the cylinder subassembly 112 may be fluidly coupled in series such that the fire suppressant contained in one of the cylinders 110 is depleted before the fire suppressant contained in the next cylinder 110 in the series is supplied. By way of example, each actuator 102 may initially be closed (i.e., not supplying fire suppressant) and in communication with the controller 30. The first actuator 102 would open, and the succeeding actuator 102 in the series would then open based on a command from the controller 30 that the fire suppressant contained in the preceding cylinder 110 is depleted.

As shown in FIG. 1, the pressure regulating portion 40 includes a series of pressure regulators 42. Each pressure regulator 42 receives fire suppressant from one of the cylinder subassemblies 112 at a first pressure, and delivers the fire suppressant to the distribution network 50 at a second pressure lower than the first pressure. Each supply conduit 104 includes an end portion, shown as regulator connection portion 44, that is fluidly coupled to one of the pressure regulators 42. As shown in FIG. 1, a first regulator connection portion 44 fluidly couples a first cylinder subassembly 112 to a first pressure regulator 42. A second regulator connection portion 44 fluidly couples a second cylinder subassembly 112 to a second pressure regulator 42. A third regulator connection portion 44 fluidly couples a third cylinder subassembly 112 to a third pressure regulator 42. In other embodiments, the fire suppression system 10 includes more or fewer pressure regulators 42 and/or cylinder subassemblies 112.

Each pressure regulator 42 may be a pressure reducing regulator that maintains the pressure downstream of the pressure regulator 42 (e.g., the reduced second pressure in the distribution manifold 46) at a desired pressure. When the downstream pressure falls below the desired pressure, the pressure regulator 42 may permit fire suppressant from the cylinders 110 to pass through the pressure regulator 42. When the downstream pressure reaches the desired pressure, the pressure regulator 42 may prevent further fire suppressant from passing through the pressure regulator 42. While the downstream pressure remains at or above the desired pressure, the pressure regulator 42 may prevent additional fire suppressant from flowing through the pressure regulator 42. The desired pressure may be predetermined (e.g., preset by an operator when initially installing the fire suppression system 10).

Each cylinder subassembly 112 may include a flow control element, shown as check valve 43, positioned between the cylinders 110 and the corresponding pressure regulator 42. By way of example, the check valve 43 may be positioned along the regulator connection portion 44 of the supply conduit 104. The check valve 43 fluidly couples the cylinders 110 of the cylinder subassembly 112 to the corresponding pressure regulator 42. The check valve 43 permits flow from the cylinders 110 to the pressure regulator 42 and limits (e.g., prevents) flow from the pressure regulator 42 back to the cylinders 110. By positioning the check valve along the regulator connection portion 44, a single check valve 43 may control the flow to all of the cylinders 110 of the cylinder subassembly 112 instead of requiring a separate check valve for each cylinder 110.

Referring to FIG. 1, a manifold, shown as distribution manifold 46, fluidly couples the downstream sides of the pressure regulators 42 to one another and to one or more valves (e.g., selector valves, ball valves, slide valves, pressure regulating valves, etc.), shown as a first selector valve 51, a second selector valve 52, and a third selector valve 53. In other embodiments, the distribution manifold 46 is connected to more or fewer pressure regulators 42 and/or selector valves.

As shown, the distribution manifold 46 includes a first section or portion or inlet manifold portion, shown as main manifold 47, fluidly coupled to a second section or portion or outlet manifold portion, shown as piping network 48. The main manifold 47 is directly fluidly coupled to each of the pressure regulators 42. The main manifold 47 unites the flow of gas downstream of each of the pressure regulators 42. The piping network 48 is directly fluidly coupled to the selector valves 51, 52, and 53. The piping network 48 distributes the united flow of gas to each of the selector valves 51, 52 and 53. Accordingly, the main manifold 47 and the piping network 48 fluidly couple the pressure regulators 42 to the first, second, and third selector valves 51, 52, 53. The distribution manifold 46 may define a single, continuous manifold volume that extends uninterrupted throughout the main manifold 47 and the piping network 48 from the pressure regulators 42 to the selector valves 51, 52, and 53. In some embodiments, the distribution manifold 46 is a single, continuous piece (e.g., a weldment of several pipes). In other embodiments, the distribution manifold 46 is formed from several pieces coupled to one another (e.g., hoses or pipes coupled by one or more fittings, etc.).

In some embodiments, two or more of the cylinder subassemblies 112 may be at different pressures before and/or after supplying the fire suppressant to the pressure regulator 42. By way of example, the fire suppressant within the cylinders 110 of the first cylinder subassembly 112 may be pressurized to 200 bar, and the fire suppressant within the cylinders 110 of the second cylinder subassembly 112 may be pressurized to 300 bar before and/or after supplying the fire suppressant to the pressure regulator 42. Regardless of this discrepancy in the first pressure on the upstream sides of the pressure regulators 42, the pressure regulators 42 may regulate the second pressure downstream of the pressure regulators 42 to be equal, such that the pressure within the main manifold 47 may be substantially homogenous.

The pressure regulators 42 supply the fire suppressant at the reduced second pressure to the distribution manifold 46 and facilitate a constant discharge. By reducing the pressure of the fire suppressant prior to (e.g., upstream of) the fire suppressant reaching the distribution manifold 46, the pressure regulators 42 may reduce stresses (e.g. hoop stresses, fatigue stresses, etc.) experienced by the distribution manifold 46 and/or other components downstream of the pressure regulators 42. Therefore, the pressure regulator 42 facilitates using lower strength materials to be used for the distribution manifold 46, reducing the overall cost of the fire suppression system 10.

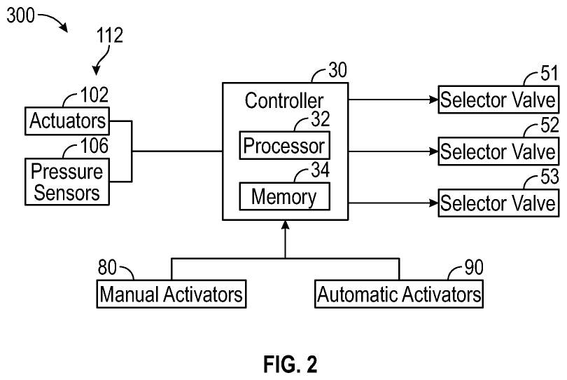

Referring to FIG. 2, the fire suppression system 10 includes a control system 300. The control system 300 includes a processing circuit, shown as controller 30. The controller 30 includes a processor 32 in communication with a memory device, shown as memory 34. The memory may contain one or more instructions that, when executed by the processor 32, cause the controller 30 to control various components of the control system 300 to perform the processes described herein.

As shown in FIGS. 1 and 2, the controller 30 may be operatively coupled to one or more of the actuators 102, the pressure sensor 106, or the selector valves 51, 52, 53. The controller 30 is configured to activate the selector valve 51 to supply the fire suppressant to the hazard 54 in response to an indication that a fire may be present near the hazard 54. The controller 30 may activate the selector valve 52 to supply the fire suppressant to the hazard 55 in response to an indication that a fire may be present near the hazard 55. The controller 30 may activate the selector valve 53 to supply the fire suppressant to the hazard 56 in response to an indication that a fire may be present near the hazard 56.

Referring further to FIG. 2, the control system 300 includes one or more first activators, sensors, or user interfaces, shown as manual activators 80, operatively coupled to the controller 30. The manual activator 80 may include one or more pull levers, buttons, knobs, switches, touch screens, or any other type of user interface device that facilitates interaction with (e.g., receiving an input from) a user. The manual activators 80 may be marked to indicate that a user should interact with the manual activators 80 (e.g., push a button, pull a pull station, etc.) in the event of a fire. In response to such an interaction, a manual activator 80 sends a fire detection signal to the controller 30 indicating that a fire has been detected or that a user believes that a fire is likely to be present.

The control system 300 includes one or more second activators, sensors, fire detection sensors, or fire detection devices, shown as automatic activators 90, operatively coupled to the controller 30. The automatic activators 90 may include temperature or heat sensors (e.g., thermocouples, linear detection wires, etc.), smoke detectors, optical sensors (e.g., cameras, infrared sensors, etc.), or other types of sensors configured to detect the presence of a fire or an indication that a fire may be present. In response to such a detection, the automatic activator 90 sends a fire detection signal to the controller 30.

In response to receiving a detection signal, the controller 30 is configured to send an activation signal to the first, second, and/or third selector valves 51, 52, 53. In some embodiments, the activation signal is an electrical signal. In other embodiments, the activation signal is or causes a flow of pressurized fluid (e.g., gas, liquid) or a movement of a mechanical member (e.g., a cable, a lever, etc.). The controller 30 may send the activation signal to one or more of the first, second, or third selector valves 51, 52, 53. Alternatively, activation of one of the first, second, or third selector valves 51, 52, 53 by the controller 30 may automatically activate the other selector valves. In response to receiving the activation signal, the controller 30 sends a signal to activate the first selector valve 51 based on a determination that the fire is present nearby the first hazard 54. Further, in response to receiving the activation signal, the controller 30 sends a signal to activate the second selector valve 52 based on a determination that the fire is present nearby the second hazard 55. Further, in response to receiving the activation signal, the controller 30 sends a signal to activate the third selector valve 53 based on a determination that the fire is present nearby the third hazard 56. In some embodiments, there may be at least one selector valve configured to supply the fire suppressant to two or more hazards.

The hazards 54, 55, and 56 (e.g., hazard areas or hazard zones) may be or include any space (e.g., room, building, enclosure, volume, area, etc.) where any asset (e.g., hard drives, power supplies, books, etc.) is stored and there is a risk of fire. Each hazard 54, 55, and 56 may have dedicated manual activators 80 and dedicated automatic activators 90. The manual activators 80 and automatic activators 90 dedicated to a specific hazard 54, 55, or 56 indicate to the controller 30 at which hazard 54, 55, and/or 56 the fire was detected. Each hazard 54, 55, and 56 may have one or more manual activators 80 and automatic activators 90 positioned near the hazard 54, 55, and 56. Accordingly, the selection of which of the selector valves 51, 52, and 53 to activate may be based on which of the manual activator 80 or the automatic activators 90 have supplied the fire detection signal. By way of example, a manual activator 80 and an automatic activator 90 may be positioned near the hazard 54, and this relationship may be predetermined and stored in the memory 34 of the controller 30. In response to receiving a fire detection signal from that manual activator 80 or that automatic activator 90, the controller 30 may activate the selector valve 51 to supply fire suppressant to the hazard 54.

Activating at least one of the first, second, or third selector valves 51, 52, 53 causes the selector valve to move to an open position and facilitates the flow of the pressurized fire suppressant through the distribution manifold 46 and at least one of the first, second, or third selector valves 51, 52, 53. The fire suppressant may then be supplied to the appropriate hazard 54, 55, or 56 through the distribution network 50. The fire suppressant may be stored in the cylinders 110 as a liquid and supplied to the hazard 54, 55, 56 as a gas. The automatic activator 90 may detect that a fire is no longer near the hazard 54, 55, 56 and send a signal to the controller 30 to deactivate at least one of the first, second, or third selector valves 51, 52, 53. By way of example, in response to the deactivation signal, the selector valve moves to a closed position that stops the flow of the pressurized fire suppressant through the distribution manifold 46 and at least one of the first, second, or third selector valves 51, 52, 53.

The distribution network 50 includes a series of conduit networks, shown as hazard piping networks 58, that supply fire suppressant to nozzles (e.g., open nozzle, sprinkler, etc.), shown as distribution nozzle 57. The fire suppressant is distributed through the nozzles 57 about at least one of the hazards 54, 55, 56 to suppress the detected fires. The hazard piping networks 58 may assemblies including one or more straight or bent sections of conduit and/or one or more fittings. The hazard piping networks 58 may be configured to deliver the fire suppressant to the hazards 54, 55, and/or 56 through one or more of the distribution nozzles 57. More distribution nozzles 57 may be needed to control or suppress the hazard 54, 55, and/or 56 if the area of the hazard 54, 55, and/or 56 is large, the intensity of the fire is great, or for other reasons. The fire suppression system 10 may supply fire suppressant through all of the distribution nozzles 57 simultaneously. Alternatively, the fire suppression system 10 may supply fire suppressant through only a certain subset of the distribution nozzles 57. In some embodiments, a fire associated with a hazard is suppressed by the fire suppressant distributed by one or more distribution nozzles 57.

As shown in FIG. 1, a first piping network 58 fluidly couples the selector valve 51 to one nozzle 57 associated with the hazard 54. A second piping network 58 fluidly couples the selector valve 52 to a pair of nozzles 57 associated with the hazard 55. A third piping network 58 fluidly couples the selector valve 53 to four nozzles 57 associated with the hazard 56.

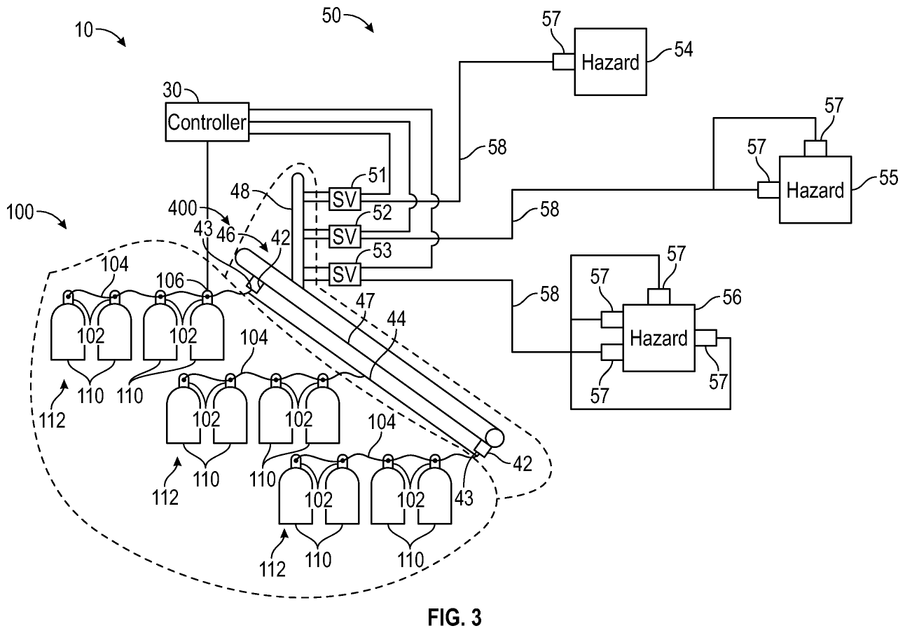

FIG. 3 illustrates an alternative embodiment of the fire suppression system 10. The fire suppression system 10 shown in FIG. 3 may be substantially similar to the fire suppression system 10 shown in FIG. 1 except as otherwise specified. An alternative embodiment of the pressure regulating portion 40 is shown in FIG. 3 as a pressure regulating portion 400. The pressure regulating portion 400 includes a regulator connection portion 44 that fluidly couples two or more cylinder subassemblies 112 to two or more pressure regulators 42. As shown, the regulator connection portion 44 is shared between three cylinder subassemblies 112 such that fire suppressant from any of the cylinder subassemblies 112 can reach a pair of pressure regulators 42. This arrangement can increase the flow rate of suppressant relative to a similar arrangement with only one pressure regulator 42. Additionally, this arrangement can provide operational redundancy in the event of a failure of one of the pressure regulators.

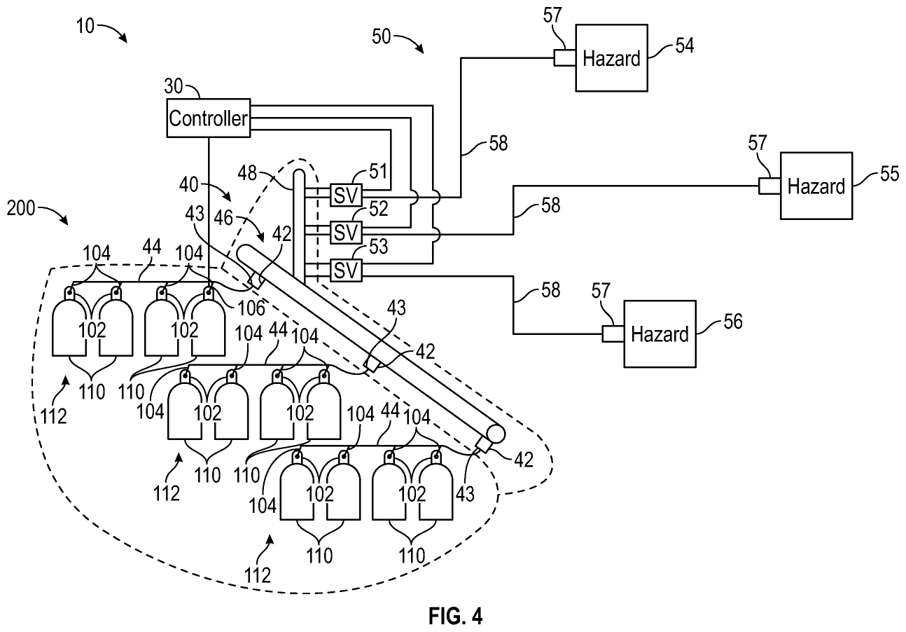

FIG. 4 illustrates another alternative embodiment of the fire suppression system 10. The fire suppression system 10 shown in FIG. 4 may be substantially similar to the fire suppression system 10 shown in FIG. 1 except as otherwise specified. An alternative embodiment of the fire suppressant supply 100 is shown in FIG. 4 as a fire suppressant supply 200. In the fire suppressant supply 200, a first, continuous section of the supply conduit 104 extends separately from the actuators 102 of each cylinder subassembly 112. A series of second sections of supply conduit 104 each extend between the first section and one of the actuators 102, fluidly coupling each cylinder 110 of the cylinder subassembly 112 to the first section of the supply conduit. Accordingly, the cylinders 110 included in the cylinder subassemblies 112 may be connected in parallel. This configuration may be advantageous if maintenance is required (e.g., to address a leak in the supply conduit, refill and/or replace a cylinder 110, etc.) on a specific cylinder 110, as the cylinder 110 can be disconnected from the supply conduit 104 without disconnecting any of the other cylinders 110.

As utilized herein with respect to numerical ranges, the terms “approximately,” “about,”“substantially,”and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire suppression system, comprising:
a first suppressant container and a second suppressant container each containing fire suppressant;
a conduit fluidly coupled to the first suppressant container and the second suppressant container;
a pressure regulator fluidly coupled to the conduit and configured to receive the fire suppressant from the conduit at a first pressure and supply the fire suppressant at a second pressure lower than the first pressure; and
a valve fluidly coupled to the pressure regulator and configured to selectively supply the fire suppressant to a hazard.

2. The fire suppression system of claim 1, wherein the pressure regulator is configured to prevent the fire suppressant from flowing through the pressure regulator in response to a pressure downstream of the pressure regulator exceeding a predetermined pressure.

3. The fire suppression system of claim 1, wherein the conduit is a first conduit and extends between the first suppressant container and the second suppressant container, further comprising a second conduit that extends between the first conduit and the pressure regulator, wherein the first conduit is fluidly coupled to the pressure regulator through the second conduit.

4. The fire suppression system of claim 1, wherein the valve is a first selector valve and the hazard is a first hazard, the fire suppression system further comprising a second selector valve fluidly coupled to the pressure regulator and configured to selectively supply the fire suppressant to a second hazard.

5. The fire suppression system of claim 4, further comprising a controller configured to:
determine that a fire is present nearby at least one of the first hazard or the second hazard;
activate the first selector valve in response to a determination that the fire is present nearby the first hazard; and
activate the second selector valve in response to a determination that the fire is present nearby the second hazard.

6. The fire suppression system of claim 5, wherein the controller is configured to determine that the fire is present nearby the at least one of the first hazard or the second hazard based on at least one of (a) a manual input from a user or (b) an input from a sensor.

7. The fire suppression system of claim 1, wherein the pressure regulator is a first pressure regulator, further comprising:
a third suppressant container;
a second pressure regulator fluidly coupled to the third suppressant container; and
a distribution manifold fluidly coupling the first pressure regulator and the second pressure regulator to the valve.

8. The fire suppression system of claim 7, further comprising a fourth suppressant container fluidly coupled to the second pressure regulator.

9. The fire suppression system of claim 1, further comprising a distribution manifold including an inlet manifold portion fluidly coupled to the pressure regulator and an outlet manifold portion fluidly coupling the inlet manifold portion to the valve.

10. The fire suppression system of claim 9, further comprising a third suppressant container and a second pressure regulator fluidly coupling the third suppressant container to the inlet manifold portion.

11. The fire suppression system of claim 10, wherein the valve is a first selector valve, further comprising a second selector valve fluidly coupled to the outlet manifold portion.

12. The fire suppression system of claim 9, further comprising a check valve positioned to prevent the fire suppressant from flowing from the distribution manifold to the first suppressant container through the pressure regulator.

13. The fire suppression system of claim 1, wherein the fire suppressant includes an inert gas.

14. The fire suppression system of claim 1, wherein the first pressure is at least 200 bar.

15. A fire suppression system, comprising:
a manifold defining a distribution volume;
a first cylinder subassembly including:
a first cylinder and a second cylinder each containing fire suppressant; and
a first pressure regulator fluidly coupled to the first cylinder and the second cylinder;
a second cylinder subassembly including:
a third cylinder and a fourth cylinder each containing fire suppressant; and
a second pressure regulator fluidly coupled to the third cylinder and the fourth cylinder;
a valve fluidly coupled to the manifold and configured to selectively supply the fire suppressant from the distribution volume to a hazard;
a controller operatively coupled to the valve and configured to activate the valve to supply the fire suppressant to the hazard in response to an indication that a fire is present; and
a check valve positioned to prevent fluid flow from the manifold to the first cylinder through the first pressure regulator.

16. The fire suppression system of claim 15, wherein the valve is a first selector valve and the hazard is a first hazard, the fire suppression system further comprising a second selector valve operatively coupled to the controller, fluidly coupled to the manifold, and configured to selectively supply the fire suppressant from the distribution volume to a second hazard.

17. The fire suppression system of claim 16, wherein the controller is further configured to:
determine a location of the fire;
activate the first selector valve in response to a determination that the fire is present nearby the first hazard; and
activate the second selector valve in response to a determination that the fire is present nearby the second hazard.

18. The fire suppression system of claim 15, wherein the fire suppressant within the first cylinder has a first pressure, and wherein the fire suppressant within the third cylinder has a second pressure different from the first pressure.

19. A method of suppressing a fire, the method comprising:
supplying a first volume of a fire suppressant from a first suppressant container to a pressure regulator;
supplying a second volume of the fire suppressant from a second suppressant container to the pressure regulator;
reducing, by the pressure regulator, a pressure of the first volume of the fire suppressant and a pressure of the second volume of the fire suppressant to a reduced pressure; and
directing the first volume of the fire suppressant and the second volume of the fire suppressant toward a hazard.

20. The method of claim 19, wherein the pressure regulator is a first pressure regulator, the method further comprising:
supplying a third volume of the fire suppressant from a third suppressant container to a second pressure regulator;
supplying a fourth volume of the fire suppressant from a fourth suppressant container to the second pressure regulator;
reducing, by the second pressure regulator, a pressure of the third volume of the fire suppressant and a pressure of the fourth volume of the fire suppressant to the reduced pressure;
directing the first volume of the fire suppressant at the reduced pressure, the second volume of the fire suppressant at the reduced pressure, the third volume of the fire suppressant at the reduced pressure, and the fourth volume of the fire suppressant at the reduced pressure into a manifold; and
directing the third volume of the fire suppressant and the fourth volume of the fire suppressant toward the hazard.
